(19) United States
(12) Patent Application Publication
(10) Pub. No.: US 2018/0081372 A1
(43) Pub. Date: Mar. 22, 2018

(54) CONVEYING SYSTEM WITH AN AUTOMATIC TETHERING FUNCTION

(71) Applicant: FORD GLOBAL TECHNOLOGIES, LLC, Dearborn, MI (US)

(72) Inventors: David THOENNESSEN, Cologne NRW (DE); Martin SCHWEIGLER, Cologne NRW (DE); Oliver NEY, Cologne NRW (DE); Mirko KUGELMEIER, Cologne NRW (DE)

(73) Assignee: FORD GLOBAL TECHNOLOGIES, LLC, Dearborn, MI (US)

(21) Appl. No.: 15/704,404

(22) Filed: Sep. 14, 2017

(30) Foreign Application Priority Data
Sep. 16, 2016 (DE) 10 2016 217 805.9

(51) Int. Cl. G05D 1/02; G01S 5/02; G05D 1/00

(52) U.S. Cl. CPC G05D 1/0276; G01S 5/0263; G05D 1/0223; G05D 1/0255; G05D 1/0088

(57) ABSTRACT

A conveying system having automatic tethering function comprises an electrically driven mobile conveying device and a portable transmitting device (“beacon”). The conveying device automatically follows the transmitting device at a predetermined distance. The conveying and transmitting devices are coupled together via a radio link and ultrasound. The transmitting device transmits a radio, and, in time correlation, an ultrasound signal. The ultrasound signal is received by the conveying device in a spatially resolved manner, and an automatic tethering function is implemented based on the radio and ultrasound signals.

### CROSS-REFERENCE TO RELATED APPLICATIONS

This application claims foreign priority benefits under 35 U.S.C. § 119(a)-(d) to DE Application 10 2016 217 805.9 filed Sep. 16, 2016, which is hereby incorporated by reference in its entirety.

### TECHNICAL FIELD

The present disclosure relates to a conveying system having an automatic tethering function.

### BACKGROUND

Relevant conveying systems can have a very compact design and supplied by conventional batteries, and are suitable, in particular, for conveying heavy objects by a person over relatively short distances at moderate speeds, for instance to convey purchases from the retail store to the parking place of a car.

In this context, the user carries on his person a transmitting device, also known as a “beacon”, and the conveying device follows the movement of the beacon at a predetermined distance, a process that is also known as “tethering”.

The present system is particularly suitable for conveying devices that have a circular perimeter, where the overall form of the conveying device in the approximate shape of a disk allows space-saving storage in a motor vehicle (for instance in the spare-wheel recess).

These conveying devices can have two casters or wheels, which are driven by an electric motor and independently controlled to allow forward, backward and cornering movements, and also turning on the spot like a caterpillar vehicle. The driven casters or wheels, which are arranged laterally, i.e. at approximately +900 and −90° in the direction of travel, are assisted preferably at the front and back (approximately at 0° and approximately at 180°) by non-driven, swivel-mounted or omni-directional casters.

These conveying devices can preferably have a platform that can also be used for carrying people.

For the conveying device to automatically follow the position of the transmitting device, the distance and direction of the shortest link between the conveying device and transmitting device must be determined by a highly reliable, positioning technique that is as accurate as possible. Conventional GPS positioning techniques are far too inaccurate, and/or not reliably available for this purpose, in enclosed spaces. Radiolocation of sufficient accuracy in terms of the direction, is likewise difficult to implement.

In automobile engineering, ultrasound technology has proved to be a reliable, accurate and relatively inexpensive distance sensing technology for moderate distances (typically up to about 3 m).

### SUMMARY

The object of the disclosure is to provide a conveying system having a suitably-designed, transmitting device, and a conveying device to provide a control method is implementable at reasonable cost with a reliable automatic tethering function.

A conveying system according to the disclosure having an automatic tethering function comprises an electrically driven mobile conveying device, and a portable transmitting device having a position, which the conveying device is meant to follow automatically at a predetermined distance.

The conveying device and the transmitting device wirelessly communicate with one another via at least two different communications channels. The first communications channel constitutes a radio link, and the second communications channel constitutes a communications channel having a more accurate positioning capability than the first communications channel to determine the distance and direction between the conveying and transmitting devices.

The conveying device is configured to follow the position of the transmitting device by exchanging (repeatedly), on the first communications channel, a first signal that requests position-finding, whereupon position-finding that determines the distance and/or direction between conveying device and transmitting device is performed via the second communications channel with assistance of the first signal. The conveying device is also configured to follow the position of the transmitting device at least based on positioning data obtained.

The second communications channel, preferably, constitutes an ultrasonic positioning system, wherein the transmitting device includes at least one ultrasonic transmitter, and the conveying device includes a plurality of ultrasonic receivers arranged in different directions.

Using both a radio communications channel and an ultrasound communications channel, with the ultrasound communications channel being used simultaneously to measure, achieves a number of advantages:

Communication over the radio channel can be configured to save energy, so that the ultrasonic transmitters, which tend to consume more energy, only need to be activated when a measurement is due, and not in standby mode, something that is important, in particular, for the mobile transmitting device, which has a relatively small energy storage device.

In addition, by correlating radio and ultrasound transmission by optional encoding, or encryption of the radio signal, an ultrasonic measurement can be largely protected from interference effects caused by other ultrasound-based systems. The receiver “knows” from the radio signal when the ultrasound signal is transmitted, in which case it is also possible to verify, if applicable, whether the ultrasound signal decays again after a defined time period, which can be used to distinguish the wanted signal from interference sources.

Lastly, the radio transmission at the speed of light allows a start time for the measurement of a distance of travel of ultrasound signals to be defined very precisely, and determine the distance with a high degree of accuracy.

The transmitting device is, preferably, configured to transmit a radio signal over the first communications channel and, correlated in time, an ultrasound signal over the second communications channel. The conveying device is, preferably, configured to use a time of arrival of the radio signal to determine a travel time of the ultrasound signal.

If the conveying device has a circular outer contour, at least in portions thereof, the plurality of ultrasonic receivers can be distributed over a defined angle range, resulting in a fan-like structure of the main receiving directions, or patterns of the receivers.

A specific expected angle segment of 120°, for example, is typically sufficient in this case, because the conveying device is constantly orienting itself with respect to the position of the transmitting device, and given that a person carrying the transmitting device is not moving too quickly, it should not normally transpire that the transmitting device moves out of the “field-of-vision” of the receivers of the conveying device. Should this happen nonetheless, the conveying device can, preferably, stop until the user brings the transmitting device back into the range of the “receiving window” of the conveying device.

Since a single ultrasonic transmitter has a relatively strong directionality, the transmitting device can, preferably, contain a plurality of ultrasonic transmitters. The plurality of ultrasonic transmitters is arranged spatially close to one another, but at different radiation directions, so that they produce, in combination, a wider sound wave.

The conveying device, preferably, comprises a vehicle dynamics control unit, which, by controlling the speed of the drive of the conveying device, corrects the distance from the transmitting device via a PID (proportional-integral-derivative) controller to a predetermined setpoint distance, in which process the conveying device, typically (in particular if no obstacles are found; see below), is moved in an ascertained direction of the transmitter, or in an opposite direction thereto (if the conveying device has come too close to the transmitting device).

Since, in practice, captured signals detected by the ultrasonic sensors are subject to noise in a variety of forms. The signals from the positioning system are, preferably, filtered by a Kalman filter, considering previous positioning data. This technique assumes that there is a low probability that very large changes in position of the transmitter have taken place in a short time interval.

In addition, the quality of the vehicle dynamics control system can also be improved by the conveying device having a positing-finding unit, in particular an IMU (inertial measurement unit), the measurement signals of the position-finding unit (from yaw-rate sensors, accelerometers and magnetic field sensors) are additionally taken into account in the vehicle dynamics control system. The vehicle dynamics control system “knows”, via these sensors, the actual response of the conveying device to drive commands, whereby a control quality can be improved (e.g. by appropriate feed-forward terms).

In a preferred embodiment, the ultrasonic receivers are additionally configured to be distance sensors that detect possible obstacles, so that the conveying system, wherever possible, can automatically drive around detected obstacles. For this purpose, all or some of the ultrasonic receivers are preferably designed as combined ultrasonic transmitters and receivers (known as transducers), which in alternation with position-finding for the beacon, scan the surrounding environment for possible obstacles, which are then avoided, if necessary, by a suitable change in direction.

The disclosure also proposes a control method for a conveying system of the type described above, wherein the conveying system comprises an electrically driven mobile conveying device, and a portable transmitting device, which the conveying device follows automatically at a predetermined distance. The method comprises the steps:

a) transmitting a first signal via a first communications channel, which is configured to be a radio channel, between a transmitting and conveying device;

b) transmitting, in real-time correlation, a second signal via a second communications channel, which, with an assistance of the first signal, facilitates a position-finding that determines a distance and direction between the conveying and transmitting devices; and

c) controlling a drive of the conveying device at least based on the position-finding such that the conveying device follows a position of the transmitting device.

The disclosure is explained in more detail below with reference to the drawings by way of example, in which:

### BRIEF DESCRIPTION OF THE DRAWINGS

FIG. 1 is a schematic view of a conveying system according to the disclosure having “tethering” function;

FIG. 2A is a polar diagram for illustrating obstacle detection; and

FIG. 2B is a polar diagram for illustrating the vehicle dynamics control system based on identifying a transmitter position.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In this context, “tethering” denotes an autonomous driving function of a conveying device, or a vehicle that maintains a defined distance from a transmitting device, referred to below as a “beacon”.

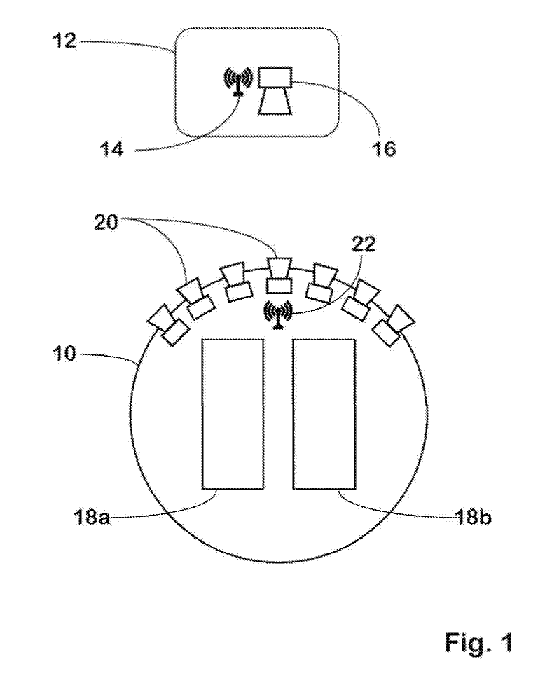

According to FIG. 1, a conveying system according to the disclosure is depicted. The system comprises a conveying device 10, which is driven and steered by a pair of schematically represented casters 18a and 18b. Ultrasonic transducers 20 are arranged concentrically along a partial circumference (approximately 120°) of a circular platform of the conveying device 10, resulting in a fan-shaped, receiving pattern. The transducers 20 can also transmit ultrasound signals, which are relevant to an obstacle detection, described later.

For the “tethering” function, the transducers 20 receive a signal from an ultrasonic transmitter 16 (which likewise can also have receive functionalities), which is part of a mobile transmitting device, or “beacon” 12. The conveying device automatically follows a position of the transmitting device.

Given a suitable position, the signal from the ultrasonic transmitter 16 is received by a plurality of ultrasonic transducers 20. A direction of the transmitter 12 with respect to the conveying device 10 can be determined, and/or estimated, from time-of-arrival (“ToA”) comparisons, and/or on an intensity distribution.

In addition, transmitting device 12 and conveying device 10 each have radio transceivers 14 and 22. The control/analysis electronics of the radio transceivers are capable of real-time processing.

A predetermined distance between conveying device 10 and transmitting device 12 is maintained by the conveying device 10 using its travel functions to follow beacon 12 movements. The practical use of following beacon movements is that a person carries the beacon 12 on his or her person, and the conveying device 10 follows this person, for instance, to carry heavy objects.

Ultrasonic transmitters/receivers and real-time radio transmission are used as the underlying technologies. The beacon 12 is equipped with a radio transmitter 14 and a plurality of ultrasonic transmitters 16. Using more than one ultrasonic transmitter in the beacon 12 allows a spatial coverage that is as good as possible through a limited transmission cone. Using a plurality of transmitters 16 pointing in different directions helps to achieve this good, spatial coverage.

The conveying device 10 is equipped with a radio receiver 22, and a plurality of ultrasonic transducers 20 (for example, unlike the figure, twelve transducers). The ultrasonic transducers 20 allow ultrasound signals to be both, received and transmitted. Only a receive function is needed for a tethering function.

The transducers 20 are oriented as sketched in FIG. 1, i.e. the ultrasonic transducers 20 are evenly distributed on the front face of the conveying device 10 over a total angle range of 120°. Each of these transducers has a limited receiving cone for incident ultrasound signals. If an ultrasound signal is transmitted from the beacon 12, then this signal is captured only by the transducers 20 that are oriented towards the beacon 12.

The position-finding procedure takes the following form in the exemplary embodiment, where the respective steps are repeated at regular time intervals:

i. the beacon 12 transmits a radio signal to the conveying device 10;

ii. the beacon 12 simultaneously transmits an ultrasound signal;

iii. the radio signal is transmitted at the speed of light to the conveying device 10, and defines the zero time for a measurement for the conveying device 10;

iv. the ultrasound signals are received with a time delay because they are transmitted only at the speed of sound;

v. the conveying device calculates the distance from the beacon 12 using a time difference between arrival of the radio ultrasound signals;

vi. the conveying device calculates a direction of the beacon using the principle of the ToA (Time of Arrival) method.

The position calculated in this way is usually contaminated with interference from outside influences, which severely impairs accuracy. Various techniques can be used to increase a position accuracy, which are explained below:

A Kalman filter is used for essential removal of noise from successive measurements. Since a change in position of the beacon 12 is bounded within a certain range by a carrying person, this signal can be expected to have a reduced rate of change, which is why the Kalman filter is a suitable algorithm for removing noise from the input signal.

Another mechanism for noise removal is to use measured values from an IMU (inertial measurement unit) installed in the conveying device 10. This unit may include yaw-rate sensors, accelerometers and magnetic field sensors, which can improve, considerably, a determination of a change in position of the conveying device 10. A PID (“proportional-integral-derivative”) controller is parameterized based on these input values, and controls vehicle dynamics according to a target direction (of the beacon 12).

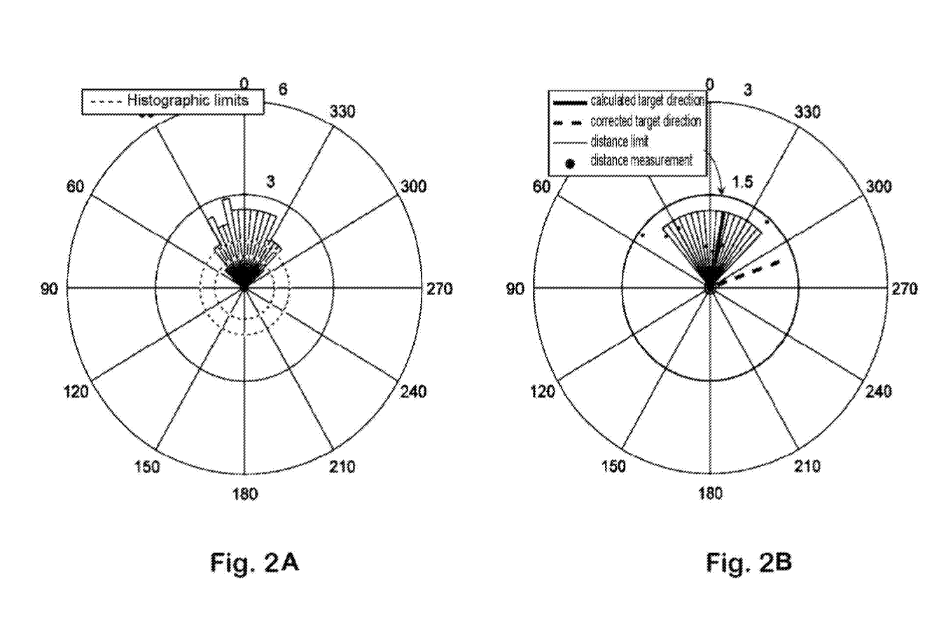

The polar diagram of FIG. 2B illustrates the calculation.

The calculated target direction (bold line) is calculated based on input data (points). Using previous travel movement and filtered input data, a control direction that is actually needed (dashed) may differ from a previously calculated target direction, wherein detected obstacles (see FIG. 2A, which shows distances, detected by a sensor fan, from obstacles) are also considered.

For obstacle-finding, the ultrasonic transducers 20 of the conveying device 10 are used not only for finding the position of the beacon 12, but also for detecting obstacles. These measurements are performed alternately with the measurements for position-finding. The principle is comparable to existing ultrasonic rangefinders. Each ultrasonic transducer in the conveying device emits a signal, and calculates a distance from a possible obstacle from a signal that may be reflected.

The disclosure can be implemented in various alternative ways without departing from the fundamental idea of the disclosure. For instance, given suitable data communications, the data processing and the control can be performed both in the conveying and transmitting devices, and, also, in another location (in a mobile device or a remote server). In addition, some, or all the communications paths may be reversed, and hence the position-finding request can be initiated readily, also by the conveying device 10 instead of by the transmitting device 12. It would also be possible, in principle, to implement the position-finding on the second communications channel by the transducers 20 on the conveying device emitting, in a cascade, an ultrasound signal successively, or at different frequencies, which is then detected by a corresponding ultrasonic receiving unit on the beacon 12.

In this case, an occupant may wish to transfer an image or information displayed on one, or more of further display systems to a display system 2, e.g. to allow the occupant to interact with the image or information using the display system 2.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A conveying system with an automatic tethering function, comprising:
a portable transmitting device; and
an electrically-driven mobile conveying device configured to automatically follow a position of the transmitting device at a predetermined distance,
wherein the conveying and transmitting devices wirelessly communicate via at least first and second communications channels, the first including a radio link and a first signal that requests position-finding, and the second including a communications channel having a positioning capability based on positioning data that determines a distance and direction between the devices to perform position-finding with assistance from the first signal.

2. The conveying system as claimed in claim 1, wherein the second communications channel is an ultrasonic positioning system such that the transmitting device includes at least one ultrasonic transmitter, and the conveying device includes a plurality of ultrasonic receivers arranged in different directions.

3. The conveying system as claimed in claim 2, wherein the transmitting device is configured to transmit a radio signal over the first communications channel and, correlated in time therewith, an ultrasound signal over the second communications channel such that the conveying device is configured to use a time-of-arrival of the radio signal to calculate a travel time of the ultrasound signal.

4. The conveying system as claimed in claim 2, wherein the conveying device has a circular outer contour, at least in portions thereof, over which the plurality of ultrasonic receivers is distributed, which results in a fan-like, receiving pattern of the receivers.

5. The conveying system as claimed in claim 1, wherein the transmitting device includes a plurality of ultrasonic transmitters.

6. The conveying system as claimed in claim 1, wherein the conveying device includes a vehicle dynamics control unit that controls a speed of a drive of the conveying device to correct the distance from the transmitting device to a predetermined setpoint distance to move in a direction of the transmitting device or in an opposite direction.

7. The conveying system as claimed in claim 2, wherein signals from the ultrasonic positioning system are filtered by a Kalman filter, considering previous positioning.

8. The conveying system as claimed in claim 6, wherein the conveying device is configured to perform position-finding such that a position measurement signal used by the vehicle dynamics control unit.

9. The conveying system as claimed in claim 4, wherein the ultrasonic receivers of the conveying device are distance sensors that automatically detect obstacles at the position.

10. An automatic tethering conveying system control method comprising:
electrically driving a mobile conveying device that automatically follows a portable transmitting device at a predetermined distance;
transmitting a first signal between the devices via a first communications channel that is a radio channel;
transmitting a time-correlated second signal via a second communications channel, which, with the assistance of the first signal, facilitates position-finding that determines a distance and direction between the devices; and
controlling a drive of the conveying device based on the position-finding such that the conveying device follows a position of the transmitting device.

11. The automatic tethering conveying system control method as claimed in claim 10 further comprising correcting the distance from the transmitting device to a predetermined setpoint distance to move the conveying device in a direction of the transmitting device or in an opposite direction via a control unit that controls a speed of a drive of the conveying device.

12. The automatic tethering conveying system control method as claimed in claim 10 further comprising distributing a plurality of ultrasonic receivers around a circular outer contour of the conveying device.

13. The automatic tethering conveying system control method as claimed in claim 12 further comprising detecting obstacles within the position using the receivers as distance sensors.

14. A vehicle comprising:
a conveying device configured to automatically follow a position of a transmitting device at a predetermined distance, wherein the devices wirelessly communicate via first and second channels, the first including a radio link and a signal that requests position-finding, and the second including a channel having a positioning capability based on positioning data that, with assistance from the signal, determines the distance and direction between the devices.

15. The vehicle as claimed in claim 14 further comprising a control unit that controls a speed of a drive of the conveying device that corrects the distance from the transmitting device to a predetermined setpoint distance to move the conveying device in a direction of the transmitting device or in an opposite direction.

16. The vehicle as claimed in claim 15, wherein the control unit uses a position measurement signal calculated from the positioning data.

17. The vehicle as claimed in claim 14, wherein the conveying device has a circular outer contour with a distributed plurality of ultrasonic receivers such that a pattern of the receivers is fan-like.

18. The vehicle as claimed in claim 17, wherein the receivers are distance sensors that automatically detect obstacles within the position.
